(19) United States
(12) Patent Application Publication
(10) Pub. No.: US 2017/0291330 A1
(43) Pub. Date: Oct. 12, 2017

(54) METHOD FOR PRODUCING A COMPOSITE PART MADE FROM AQUEOUS RESIN AND COMPOSITE PART COMING FROM SUCH A METHOD

(71) Applicants: FAURECIA AUTOMOTIVE INDUSTRIE, Nanterre (FR); LINEO NV, Meulebeke (BE); PEUGEOT CITROEN AUTOMOBILES SA, Vélizy-Villacoublay (FR); UNIVERSITE DE REIMS CHAMPAGNE-ARDENNE, Reims Cedex (FR)

(72) Inventors: Steve JEUNESSE, Mouzon (FR); Valérie MARCEL, Brandeville (FR); Moussa KHALFALLAH, Reims (FR); Boussad ABBES, Beaumont-sur-Vesle (FR); François VANFLETEREN, Bernay (FR); Frédéric ROUSSEAU, Dourdan (FR)

(21) Appl. No.: 15/514,442

(22) PCT Filed: Apr. 29, 2015
(86) PCT No.: PCT/EP2015/059420

§ 371 Date: Mar. 24, 2017

(30) Foreign Application Priority Data
Sep. 24, 2014 (FR) 1459031

(51) Int. Cl. B29C 37/00; B29C 33/02; B29C 43/36; E04C 2/36; B29C 70/34; B29D 24/00; B32B 3/12; B29C 33/10; B29C 35/02

(52) U.S. Cl. CPC B29C 37/006; B29C 33/10; B29C 33/02; B29C 43/36; B29C 35/02; B29C 70/34; B29D 24/005; B32B 3/12; E04C 2/365; B32B 2250/40; B29L 2007/002

(57) ABSTRACT

A method for producing a composite part. The method includes the following steps: stacking a first mat, a spacer and a second mat in a heatable mold; at least one of the mats including a continuous web of fibers impregnated with a thermosetting resin; and compressing and heating of the stack by the heatable mold, in order to polymerize the thermosetting resin. The stacking step includes the deposition, in a heatable mold, of a first and a second filtration layer, in contact respectively with the first and second mats, on the opposite side from the spacer. The filtration layers are porous to steam and relatively less porous to the thermosetting resin. During the compression and heating step steam is evacuated from the mold.

### TECHNICAL FIELD

The present invention relates to a method for manufacturing a structural composite part, notably for an automobile vehicle, as well as to the structural composite part which results therefrom.

More particularly, the invention relates to a method for manufacturing a structural composite part, comprising the following steps:
a step for stacking, in a heated mold, a first mat, a spacer and a second mat; the spacer being positioned between the first and the second mat; at least one of the first and second mats including a continuous web of fibers impregnated with a composition including a thermosetting resin, said web comprising a plurality of parallel fibers connected to each other by the composition;
a step for compressing and heating the stack with the heated mold, the heating being achieved at a temperature and for a period allowing polymerization or cross-linking of the thermosetting resin.

### BACKGROUND

Such a method, for example described in document WO2012/056202, gives the possibility of obtaining, in a single molding or thermomolding step, a panel formed with two mats, or composite skins, separated by a spacer. The resin present in the skins also ensures that the skins are secured to the spacer.

The spacer is generally in cardboard, in a honeycomb structure form. Excessive pressure during the compression step would cause its crushing making the panel unusable. This is what occurs when the skins consist of entangled fiber mats produced by carding-topping-needling as described in WO2012/056202.

In order to overcome this problem, it is known how to replace the type of mats described in WO2012/056202 with a superposition of webs comprising a plurality of parallel fibers, or unidirectional webs, which have a higher density than webs stemming from carding-topping. The method for obtaining such webs is for example described in WO2013/068355.

This high density of the webs gives the possibility of obtaining an optimum density of the skins in order to produce a composite panel, without any excessive pressure during the compression step. Indeed, the mat formed with the superposition of the webs before thermoforming already has practically the required density for the composite.

However, when the thermosetting resin is with an aqueous base and/or generates water during its polymerization or cross-linking, this water in the form of steam may perturb the securing of the skins with the spacer and/or cause a local collapse of the spacer. The panel is then impossible to utilize.

Moreover, the cross-linking reaction requires a minimum water level, of the order of 5 to 10% by weight of resin, present before cross-linking, in order to allow mobility of the molecules which react. An “initial” lack of water leads to flawed cross-linking, which is expressed by fibers poorly adhered with each other and/or skins which are poorly adhered to the spacer

Further, even if the panel does not have the defects described above, the water which cannot be removed during the compression remains present in the product before removal from the mold which limits the density of the skins (high porosity in the finished product) and therefore the mechanical performances of the panel.

The only known way for limiting these problems is to minimize the provision of initial water by controlling at best the humidity level in the web at the output of the impregnation step, for example by limiting it to between 5 and 10%.

Now, on the other hand, controlling so finely and maintaining a humidity level is not an easy task, in particular because of the storage which may be for a long time. On the other hand, high porosity of the skins causes degradation of the mechanical performances of the panel.

### SUMMARY

An object of the present invention is to provide a simple method for manufacturing a structural composite part, giving the possibility of retaining optimum humidity of the resin without the steam generated by the heating perturbing the integrity of the part.

A second object of the invention is to produce a composite part including skins with high density, therefore of low porosity, forming real composites.

Another object of the invention is to facilitate impregnation and conditioning of the web.

For this purpose, the invention relates to a method for manufacturing a structural composite part of the aforementioned type, wherein:
the stacking step includes the positioning, in the heated mold, of a first and second filtering layers, the first and second filtering layers being respectively positioned in contact with the first and the second mats, on the opposite side of the spacer; the first and second filtering layers being porous to steam, and relatively less porous to the thermosetting resin; and
the heated mold includes means for removing steam formed during the compression and heating step.

According to other advantageous aspects of the invention, the method includes one or several of the following features, taken individually or according to all the technically possible combinations:
the composition including the thermosetting resin is an aqueous solution and/or the thermosetting resin generates water during its polymerization or cross-linking;
at least one of the first and second filtering layers has a resistance to the passage of air comprised between 30 N·s/m³ and 300 N·s/m³, preferably comprised between 50 N·s/m³ and 200 N·s/m³;
the method comprises beforehand a step for spraying water on the first mat and/or on the second mat;
the compression and heating step leads to the attachment of the first and the second filtering layers, on the first and on the second mats respectively;
the method comprises beforehand the manufacturing of a mat, said manufacturing comprising the following steps: a step for providing a continuous web of fibers parallel with each other, a step for impregnating the web with a composition including a thermosetting resin, and a step for drying the web;
the provision of the continuous web comprises the following steps: a step for bringing in parallel a plurality of disconnected ribbons of fibers, a step for dispersing the adjacent ribbons through a field of spikes in order to form a strip of parallel fibers, and a step for tensioning and stretching the strip in the field of spikes parallel to a traveling axis;
the step for stacking the first and/or the second mats comprises the stacking in the heated mold of a plurality of continuous webs of parallel fibers;
the parallel fibers of each web are positioned so as to form a non-zero angle, preferentially a right angle, with the parallel fibers of each other adjacent web;
the method includes, before the stacking step, the following steps: definition of a desired surface mass for the first mat and for the second mat after impregnation with the composition comprising the resin; calculation of an air gap between the spacer and each wall of the mold, on the basis of the surface mass of each mat, on the thickness of each filtering layer and on the dry extract of the resin, without taking into account the water content of the resin.

The invention further relates to a structural composite part which may stem from a method as described above, said part including a first mat, a spacer and a second mat, the spacer being positioned between the first mat and the second mat, at least one of the first and second mats including a continuous web of fibers impregnated with a composition including a thermosetting resin, said web comprising a plurality of bound fibers parallel with each other by the composition, said part including a first and second layers respectively positioned in contact with the first and the second mats, on the side opposite to the spacer, the first and the second layers being porous to steam and relatively less porous to the thermosetting resin.

### BRIEF DESCRIPTION OF THE DRAWINGS

The invention will be better understood upon reading the description which follows, only given as a non-limiting example and made with reference to the drawings wherein:

FIG. 1 is a sectional view of a structural composite part according to an embodiment of the invention;

FIG. 2 is a sectional view of a device for manufacturing the composite part of

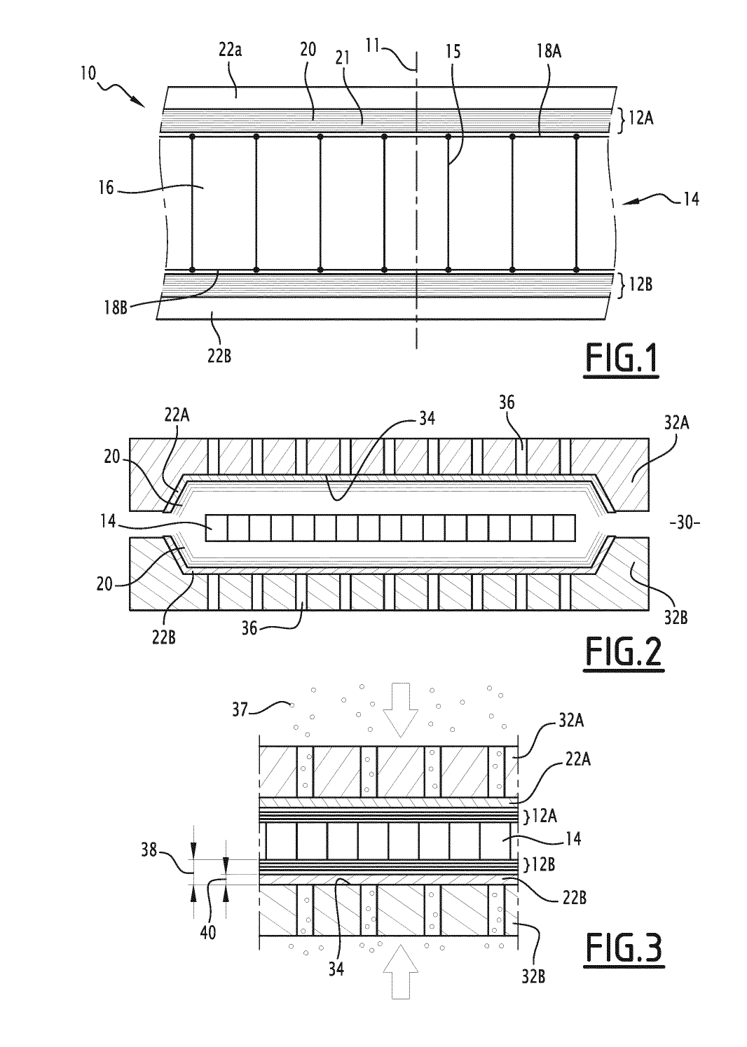

FIG. 1, during a step of a manufacturing method according to an embodiment of the invention;

FIG. 3 is a partial sectional view of the device of FIG. 2, during another step of said manufacturing method.

### DETAILED DESCRIPTION

FIG. 1 is a sectional view of a structural composite part 10 of an automobile vehicle. The part 10 is a structuring part of the automobile vehicle, for example a panel, such as a rear shelf for hiding the trunk, a false compartment or trunk floor, or a sub-motor.

An axis 11, substantially perpendicular to an average plane of the structural part 10 is considered.

The structural composite part 10 includes a first 12A and a second 12B mat, and a spacer 14, interposed between both mats 12A, 12B.

The spacer 14 is preferably formed in a lightweight material, such as paper or cardboard. Advantageously, the spacer 14 is made on the basis of a honeycomb structure. Thus, the spacer 14 has a plurality of walls 15 substantially parallel to the axis 11. The walls 15 delimit central spaces 16 with a closed contour, for example of a polygonal shape, forming the cells.

The spacer 14 includes opposite faces 18A, 18B, formed by the ends of the walls 15 along the axis 11. The faces 18A, 18B thus exhibit a discontinuous surface. Each mat 12A, 12B is attached on the one face 18A, 18B.

The surface mass of the spacer 14 is preferably small, notably less than 1,500 g/m² and more preferentially comprised between 400 g/m² and 1,200 g/m².

At least one of the first 12A and second 12B mats includes at least one continuous web 20 of fibers, said web 20 comprising a plurality of bound fibers parallel with each other by a thermosetting resin 21.

The web 20 is said to be <<a unidirectional web>> or <<a unidirectional layer>>, i.e. the fibers of the web 20 are positioned parallel with each other along a longitudinal direction. Such webs are notably described in document WO2013/068355.

Advantageously, at least some of the fibers of the web 20 are long fibers, i.e. have a length of more than 20 cm, more preferentially greater than 50 cm. The length of the long fibers is for example comprised between 50 and 80 cm. The long fibers give the web 20 interesting mechanical strength properties, as for example described in document WO2013/068355.

Advantageously, at least some of the fibers of the web 20 are natural fibers. In an embodiment, all the fibers of the web 20 consist of natural long fibers. Alternatively, a portion of the fibers of the web 20 is formed with artificial or synthetic fibers, distinct from the natural long fibers, or with a mixture of these fibers.

The natural long fibers are advantageously fibers extracted from plants, notably flax fibers. Alternatively, the natural long fibers are sisal, jute, hemp, kenaf fibers. Artificial fibers are for example selected from regenerated cellulose fibers, like viscose.

The synthetic fibers are for example polyolefin fibers, notably selected from among polyethylene, polypropylene, polyester, polyamide, polyimide fibers and mixtures thereof. Alternatively, the synthetic fibers are two-component fibers formed with a polymer and a copolymer, the polymer and its copolymer having different melting points.

Preferentially, the synthetic fibers are based on thermoplastic polymers, which allows, during a thermoforming step at the melting temperature of the polymer, the making of a binding of the natural fibers.

Advantageously, the mass proportion of long fibers of natural origin of the web 20 is greater than 50% of the total mass of the fibers of the web 20.

In the example illustrated in FIG. 1, each of the first 12A and second 12B mats includes a plurality of webs 20 as described above, these webs 20 being stacked over each other. For example, each of the mats 12A, 12B include between three and eight stacked webs.

Advantageously, the parallel fibers of each web 20 are positioned so as to form a non-zero angle, notably a right angle, with the parallel fibers of each other adjacent web. Such an arrangement allows reinforcement of the corresponding mat 12A, 12B, depending on the orientation of the stresses of the finite part in a situation.

Depending on the intended function of the structural part 10, the first 12A and second 12B mats include the same number of stacked webs 20, or alternatively different numbers of stacked webs 20.

The resin 21 is preferentially a resin with an aqueous base, more preferentially an acrylic resin. This type of resin is of a great interest in association with natural fibers since its affinity with this type of fibers is excellent, for moderate cost and environmental impact. An example of an acrylic resin which may be used is marketed by BASF under the name of Acrodur®.

The external faces of the part 10 are formed with a first 22A and a second 22B surface layer. The first 22A and the second 22B surface layers are respectively in contact with the first 12A and the second 12B mats.

The first 22A and the second 22B surface layers are preferentially formed with a material of the non-woven type. For example this is a carpet or a non-woven of the spunbonded type. Advantageously, each layer 22A, 22B is secured to the corresponding mat 12A, 12B by partial impregnation of resin 21.

The first 22A and the second 22B surface layers are used as outer cladding for the part 10. Another function of the layers 22A, 22B will be detailed below.

For this purpose, the first 22A and the second 22B surface layers have controlled porosity. More specifically, the first 22A and the second 22B surface layers are porous to steam and not porous to the thermosetting resin 21.

The porosity is notably defined by the resistance to passage of air (RPA), measured according to the ISO 9053 standard. Preferentially, at least one of the first 22A and second 22B surface layers has an RPA comprised between 30 N·s/m³ and 300 N·s/m³, more preferentially comprised between 50 N·s/m³ and 200 N·s/m³.

A method for manufacturing the structural part 10 will now be described.

Such a method first of all includes the making of a continuous web 20 of fibers. Such a web is for example manufactured in the way described in document WO2013/068355, according to the following steps: bringing in parallel a plurality of disconnected ribbons of fibers; dispersion of the adjacent ribbons through a field of spikes for forming a strip of parallel fibers; tensioning and stretching the strip in the field of spikes parallel to the traveling axis.

Optionally, this formation of the web 20 is followed by the addition of a binder able to ensure the transverse cohesion of the fibers with each other. This binder is for example sprayed water, able to dissolve the natural cements of fibers, which then stick the fibers to each other while drying. This optional step is described in document WO2013/068355.

According to an alternative, the cohesion of the fibers with each other is directly ensured by the next step of the method, which applies the impregnation of the web with a composition comprising the thermosetting resin 21.

Optionally, the composition further includes at least one adjuvant, such as a surfactant and/or a thickener. As indicated above, an example of compositions which may be used is the range of Acrodur® products from BASF.

The impregnation step may be achieved in different known ways, such as a vaporization of the composition on the web or coating by contact.

The impregnation step is preferentially followed by a drying step, in order to remove a portion of the water contained in the composition. This drying gives the possibility to the resin of ensuring a certain cohesion of the fibers with each other, without any cross-linking. The transient binding between the fibers is relatively weak and only has the purpose of allowing handling of the web 20.

The drying is preferentially increased until the percentage of water present in the web is less than 5%, preferentially less than 3%. In this water percentage, the water present inside the fibers themselves which may vary according to their nature, is not taken into account. In this case, this will be referred to as total drying and of a dry web.

The web 20 impregnated with resin 21 may thus be conditioned for storage, for example as a roll intercalated with an intermediate sheet as described in document WO2013/068355. The thereby conditioned web 20 may be transported onto a molding or thermomolding location, and optionally again stored.

The advantage of having a dry web lies in the possibility of using for conditioning, an ordinary paper. Indeed, when water remains present in a too large amount—beyond 5%—with the resin in the web, the latter may remain tacky or sticky and adhere to the intercalating sheet which causes losses of time during the preparation of the mats 12A, 12B. It is then necessary, in order to avoid this drawback, to use dividers of the silicone papers or films type. As these dividers cannot be reused, they are to be considered as consumables which may significantly impact the cost of the web.

As an alternative to the embodiment above, the following molding or thermoforming steps, described hereafter, are achieved at the output of the impregnation line of the web 20 with the composition comprising the thermosetting resin 21.

FIG. 2 illustrates a device 30 for manufacturing the composite part 10 according to an embodiment of the invention. The device 30, in this case a heated mold, includes a first portion 32A and a second portion 32B. The first and second portions 32A, 32B form an internal surface 34 mating the desired shape of the part 10.

The heated mold 30 includes means for discharging steam generated inside the mold. For example, perforations 36 cross a thickness of at least one, and preferentially both portions 32A, 32B. More specifically, the perforations 36 both open onto the internal surfaces 34 of the portions 32A, 32B and on the outside of the mold 30.

The mold 30 further comprises means (not shown) for heating the portions 32A, 32B and for compressing said portions 32A, 32B against each other.

The molding or thermoforming of the composite part 10 comprises the arrangement of the first 22A and the second 22B surface layers in contact with internal surfaces 34, of the first portion 32A and of the second portion 32B, respectively.

Unidirectional webs 20 impregnated with resin 21, not cross-linked, as described above, are then stacked above the first 22A and the second 22B surface layers, in order to respectively form the first 12A and the second 12B mats. As indicated above, the webs 20 of a same mat 12A, 12B are preferentially stacked so as to cross the directions of the fibers of two adjacent webs 20.

Alternatively, one or several other types of materials are inserted with the unidirectional web(s) 20 in order to form the mats 12A, 12B.

Preferentially, before stacking in the mold 30, the webs 20 impregnated with non-cross-linked resin 21 are sprayed with water, for example by spraying, in order to re-establish a suitable humidity level for the cross-linking reaction. Indeed, if the webs 20 are stored in the way described above before the molding or thermoforming step, it is possible that the residual amount of water in the resin 21 is insufficient.

Preferentially, the humidity level considered as suitable for the cross-linking reaction is of at least 5%. However, a greater level, for example greater than 10%, does not generally interfere with the cross-linking. The amount of water provided during this spraying step does not require being specifically controlled, which greatly facilitates the application of this step.

After stacking the layers forming the mats 12A, 12B, both portions 32A, 32B of the mold are positioned facing each other, the spacer 14 being placed between the first 12A and the second 12B mats, as illustrated in FIG. 2.

The method then includes a step for compressing and heating the stack with the mold 30, as illustrated in FIG. 3. The compression is carried out by bringing either one of the portions 32A, 32B of the mold 30, closer to each other as symbolized by the white arrows. The heating is achieved at a temperature and for a period allowing cross-linking of the thermosetting resin 21. The heating temperature is for example comprised between 150° C. and 250° C. for an acrylic resin.

Upon cross-linking, the resin 21 firmly binds the fibers of each web 20 with each other, and the different webs 20 with each other, as well as the mats 12A, 12B with the spacer 14. Preferentially, the compression and heating step leads the resin 21 to occupy the whole of the space between the fibers of the webs 20 and of the possible other materials forming the mats 12A, 12B.

The mats 12A, 12B formed with unidirectional webs 20 are dense and of a small thickness. The compression may be achieved at a relatively low pressure, which gives the possibility of avoiding deterioration of the spacer 14, notably of its honeycomb structure.

The heating leads to the evaporation of the water impregnating the webs 20. Further, the cross-linking of certain resins, like acrylic resins, generate water.

Because of the controlled porosity of the first 22A and of the second 22B surface layers, the thereby generated steam 37 crosses the surface layers 22A, 22B and is discharged from the mold 30 through the perforations 36. On the other hand, the resin molecules 21, of a much larger size than the water molecules, are retained by the surface layers 22A, 22B. Said surface layers 22A, 22B therefore have a function for filtering the steam during the compression and heating step.

Advantageously, during the compression and heating step, some resin 21 reacts with the surface fibers of the surface layers 22A, 22B and/or impregnates said surface fibers. At the end of the compression and heating step, the first 22A and the second 22B surface layers are then again found attached, respectively on the first 12A and on the second 12B mats.

During the compression step, a distance 38 or an air gap should be maintained between the spacer 14 and the internal surface 34 of the mold 30. More specifically, the air gap 38 represents the minimum distance between the spacer 14 and the internal surface 34, i.e. the distance at the end of the compression step.

Advantageously, the air gap 38 is selected according to the sought density for the composite skins formed by the mats 12A, 12B after cross-linking of the resin 21. If the air gap 38 is insufficient, the compression is too large and some resin 21 risks crossing the surface layers 22A, 22B and adhesively bonding said layers 22A, 22B to the internal surface 34 of the mold 30. On the contrary, if the air gap 38 is too large, the compression is insufficient and the composite is not densified enough.

Another parameter related to the selection of the air gap 38 is the amount of dry extract of resin 21 in the mats 12A, 12B. For example, for the composite part 10 of FIG. 1, the desired surface mass for the composite forming the mats 12A, 12B is of 1,000 g/m². The total weight of the fibers forming the stacked webs 20 for forming each mat 12A, 12B, like in FIG. 2, is for example 400 g/m². The amount of dry extract of resin 21 of each mat 12A, 12B should therefore be 600 g/m².

The sought density for the composites formed by the mats 12A, 12B after cross-linking is for example equal to 1. The air gap 38 should therefore correspond to a weight of 1,000 g/m² for a density of 1, i.e. 1 mm, added with the thickness 40 of the surface layer 22A or 22B. As an example, the thickness 40 is 0.2 mm for a surface layer of 120 g/m².

Thus, the method described above allows discharge of the generated steam during the compression and heating step, without the resin 21 overflowing from the mold 30 through the perforations 36 and/or blocking the perforations 36.

Moreover, the selection of the air gap 38 only depends on the amount of resin dry extract, in the webs 20 before cross-linking, and not on the total weight of resin. The amount of water in the resin before cross-linking may therefore be modified at will. Water may notably be sprayed on the webs 20 before stacking in the mold 30, as described above, in order to guarantee a humidity level favorable to the cross-linking reaction.

Moreover, this method gives the possibility of using dry webs, which avoids the use of expensive dividers and an accurate control of the humidity level in the web.

Such a method therefore gives the possibility of getting rid of the diverse problems related to water, associated with the existing methods. This method therefore allows the making of performing panels at a low cost.

As an alternative to the embodiment described above, the spacer 14, before its introduction into the mold between the mats 12A and 12B, is coated on both faces 18A, 18B with an adhesive which will react under the effect of the temperature of the mold. This alternative gives the possibility of ensuring better adhesion between the mats 12A, 12B and the spacer 14, since the amount of adhesive is better controlled than in the case when the adhesive bonding is only ensured by the resin 21 already present in the webs.

In this case, the molding device 30 described above also gives the possibility of discharging the possibly generated/discharged water by the adhesive during the heating step.

1. A method for manufacturing a structural composite part, said method comprising the following steps:
a stacking step for stacking, in a heated mold, a first mat, a spacer and a second mat, the spacer being positioned between the first and the second mat; at least one of the first and second mats including a continuous web of fibers impregnated with a composition including a thermosetting resin, said web comprising a plurality of parallel fibers bound together by the composition; and
a compression and heating step for compressing and heating the stack with the heated mold, the heating being performed at a temperature and for a duration allowing polymerization or cross-linking of the thermosetting resin;
wherein:
the stacking step includes the positioning, in the heated mold, of a first and a second filtering layers, the first and the second filtering layers being respectively positioned in contact with the first and the second mats, on the side opposite to the spacer; the first and the second filtering layers being porous to steam and relatively less porous to the thermosetting resin; and
the heated mold includes means for removing steam formed during the compression and heating step.

2. The method according to claim 1, wherein the composition including the thermosetting resin is an aqueous solution and/or the thermosetting resin generates water during its polymerization or cross-linking.

3. The method according to claim 1, wherein at least one of the first and second filtering layers has a resistance to the passage of air comprised between 30 N·s/m³ and 300 N·s/m³, preferably comprised between 50 N·s/m³ and 200 N·s/m³.

4. The method according to claim 1, comprising beforehand a water spraying step on the first mat and/or on the second mat.

5. The method according to claim 1, wherein the compression and heating step leads to the attachment of the first and of the second filtering layers, on the first and on the second mats respectively.

6. The method according to claim 1, comprising beforehand the manufacturing of a mat, said manufacturing comprising the following steps:
a step for providing a continuous web of fibers parallel with each other,
a step for impregnating the web with a composition including a thermosetting resin, and
a step for drying the web.

7. The method according to claim 6, wherein the provision of the continuous web comprises the following steps:
a step for bringing into parallel a plurality of disconnected ribbons of fibers;
a step for dispersing adjacent ribbons through a field of spikes in order to form a strip of parallel fibers;
a step for tensioning and stretching the strip in the field of spikes parallel to a traveling axis.

8. The method according to claim 1, wherein the stacking step for stacking the first and/or the second mats comprises the stacking in the heated mold of a plurality of continuous webs of parallel fibers.

9. The method according to claim 8, wherein the parallel fibers of each web are positioned so as to form a non-zero angle, preferentially a right angle, with the parallel fibers of each other adjacent web.

10. The method according to claim 1, including before the stacking step the following steps:
defining a desired surface mass for the first mat and for the second mat after impregnation by the composition comprising the resin;
calculating an air gap between the spacer and each wall of the mold on the basis of the surface mass of each mat, of the thickness of each filtering layer and of the dry extract of the resin, without taking into account the water content of the resin.

11. A structural composite part issued from a method according to claim 1, said part including a first mat, a spacer and a second mat, the spacer being positioned between the first mat and the second mat, at least one of the first and second mats including a continuous web of fibers impregnated with a composition including a thermosetting resin, said web comprising a plurality of parallel fibers bound together by the composition,
the structural composite part including a first and a second layers, respectively positioned in contact with the first and the second mats, on the side opposite to the spacer; the first and the second layers being porous to steam and relatively less porous to the thermosetting resin.
